(19) United States
(12) Patent Application Publication
(10) Pub. No.: US 2025/0153986 A1
(43) Pub. Date: May 15, 2025

(54) INDUSTRIAL TRUCK AND METHOD FOR OPERATING THE SAME

(71) Applicant: Jungheinrich Aktiengesellschaft, Hamburg (DE)

(72) Inventors: Hubert Bibernell, Landshut (DE); Carsten Schöttke, Moosburg (DE); Christian Kohrs, Plochingen (DE)

(21) Appl. No.: 18/946,439

(22) Filed: Nov. 13, 2024

(30) Foreign Application Priority Data
Nov. 14, 2023 (DE) 10 2023 131 686.9

(51) Int. Cl. B66F 9/08; B66F 9/075; B66F 9/22

(52) U.S. Cl. CPC B66F 9/082; B66F 9/0755; B66F 9/22; B66F 9/0759

(57) ABSTRACT

The present invention relates to an industrial truck (10) comprising a truck body (12) having a longitudinal direction and a width direction, a mast (20) which extends substantially vertically from the truck body (12), an active position control system (22) which is adapted to effect a relative movement of the mast (20) relative to the truck body (12), at least one support member (28) which extends between a first attachment point (24) on the truck body (12) and a second attachment point (26) on the mast (20), and a support element adjustment system (30) which is adapted to adjust a length of the support element (28) when the mast (20) moves relative to the truck body (12) so as to compensate for the resulting relative displacement of the second attachment point (26) relative to the first attachment point (24). The invention further relates to a method of operating such an industrial truck.

The present invention relates to an industrial truck comprising a truck body having a longitudinal direction and a width direction, a mast extending substantially vertically from the truck body, an active position control system which is adapted to effect a relative movement of the mast with respect to the truck body, for example to suppress vibrations of the mast or to compensate for a deflection of the mast when a load is put into or taken out of store, and at least one support element which extends between a first attachment point on the truck body and a second attachment point on the mast. The invention also relates to a method of operating such an industrial truck.

It is known from the prior art and in particular from DE 10 2020 116 337 A1, for example, to provide active systems in industrial trucks to prevent mast vibrations and to compensate for mast deformations. Such systems usually comprise a detection unit which detects a state of the truck and/or its environment, actuators being operated on the basis of this detection which cause a movement of the truck's mast relative to the truck body, for example to reactively or proactively suppress mast vibrations.

It is also known to provide support devices in industrial trucks which extend between an attachment point on a truck body of the corresponding truck and a further attachment point on the mast of such a truck in order to provide improved support and force transmission between the mast and the truck body. By way of example, reference should be made in this context to EP 3 263 510 A1 which describes an industrial truck having such a support device, to which a device for reducing vibrations is also assigned.

In practice, however, it has been shown that although a combination of these two systems, i.e. an active position control system of the mast and a support element, may in principle be advantageous and desirable in order to combine the aforementioned advantages of the two systems, at the same time the problem arises that, with such a support device of rigid design, the mast can also be rotated about a vertical axis when deflected by the active position control system. A rigid coupling of this kind would in turn lead to additional uncontrolled movements of loads carried by the mast. Although a less rigid attachment of the mast via a corresponding support element would be advantageous from this point of view, the actual task of goal transmission and attachment of the mast to the truck body via the two attachment points would be carried out less effectively.

Hence, it is desirable to realize a combination of an active position control system and at least one support element in an industrial truck wherein unwanted interactions between the two components mentioned above should be excluded and, consequently, active position control of the mast should be enabled while at the same time optimally supporting the mast through at least one support element on the truck body.

To solve this problem and to eliminate the disadvantages of the prior art mentioned above, the invention proposes additionally equipping a corresponding generic industrial truck with a support element adjustment system which is adapted to adjust a length of the support element in the case of a movement of the mast relative to the truck body so as to compensate the resulting relative displacement of the second attachment point relative to the first attachment point. In this way it is possible to dynamically adjust the length of the at least one support element in the industrial truck according to the invention so that optimum stability and an optimum flow of forces can be maintained at all times and in all states of the mast. In other words, a movement of the second attachment point provided on the mast is compensated for by suitably changing the bracing length of the at least one support element towards the truck body.

It should first be explained that the reference to a “substantially vertically” aligned mast should be taken to mean that the mast is initially in a state of vertical alignment when it is in an undeflected resting state, allowing optimum handling of loads and the like by means of a height-adjustable load handling device assigned to the mast. At the same time, however, the active position control system should enable the mast to be deflected relative to the vertical according to at least one degree of freedom, the position control system being adapted in particular to pivot the mast about an axis parallel to the longitudinal direction of the truck body.

It should also be noted that the active position control system of the truck according to the invention can comprise at least one sensor for detecting a state of the truck and/or its environment, at least one actuator for triggering the relative movement of the mast with respect to the truck body, a control unit for processing the data supplied by the at least one sensor unit and for triggering the at least one actuator and, where appropriate, a prediction unit, which may, for example, be integrated with the control unit and be capable of predicting expected future disturbances from the detected current spatial and movement status of the truck and knowledge of its environment, and of proactively triggering the at least one actuator in order to prevent or at least reduce predicted or expected vibrations or other disturbances of the mast. The aforementioned means can also be used to compensate for a deflection of the mast when a load is put into or taken out of store, where this is detected by a suitable sensor.

To also constantly ensure the flow of forces with respect to the at least one support element during all possible operating states of the industrial truck according to the invention, the support element can first be adjusted in a suitable manner with respect to its neutral position before the industrial truck is put into operation, so as to achieve the desired behavior of the support element with regard to the absorption and transmission of forces with the mast in the non-deflected neutral position. Furthermore, in this way, a deflection of the mast relative to the truck body is suitably compensated by the support element and the support element adjustment system in such a way that the force transmission remains as unchanged as possible and the flow of forces is maintained in all states of the mast.

In principle, different configurations of the support element and the support element adjustment system are conceivable in industrial trucks according to the invention in order to achieve the desired properties or the intended mode of operation thereof.

In a first conceivable variant, the at least one support element can comprise a rigid first section and a second section that is length-adjustable with respect to the first attachment point, and the support element adjustment system can comprise a mechanical coupling between the mast and the second section. Here, the term “length-adjustable” second section should be understood to mean, for example, that the distance between the end of the first section adjacent to the second section and the first attachment point can also be achieved by suitably pivoting a lever to be understood as the second section of the support element or by providing an eccentric disk. In general terms, therefore, the second section is a component by means of which the change in length of the support element between the two attachment points can be realized in a general manner. Another example of this is a so-called “support-integrated” second section, which can be configured as a length-adjustable element provided at any position along the length of the support element, for example by a telescopic section, a length-adjustable actuator or similar, in order to be able to adjust the length of the support element at this point at a distance from the two attachment points thereof.

With regard to the above-mentioned variant of a mechanical coupling of the support element adjustment system, several specific embodiments are furthermore conceivable. For example this mechanical coupling can be implemented with the aid of a linkage which, by means of an attachment to the mast via a pivotable element, causes the second section of the support element to pivot in order to change the length of the support element. Such an embodiment can therefore be formed with a simple and rigid connection between the corresponding pivoting joints or, for example, via an articulated lever with corresponding swivel joints.

A further embodiment of such a mechanical coupling of the support element adjustment system can be implemented with the aid of a Bowden cable, which causes a change in the length of the support element by means of an attachment to the mast when the mast is moved relative to the truck body. In one such embodiment, the length-adjustable second section of the support element is configured in such a way that the transmission of force by means of the said Bowden cable allows both a shortening and a lengthening thereof in order to be able to suitably convert any movements of the mast relative to the truck body into a lengthening or shortening of the support element.

It is further conceivable to implement the mechanical coupling of the support element adjustment system by means of a cardan shaft, a spindle drive, a chain drive or a belt drive, a rotary movement of the corresponding drive being triggered by an attachment to the mast when the mast moves relative to the truck body, which causes the second section of the support element to pivot so as to change the length of the support element. Depending on the specific design, the corresponding second section of the support element can, for example, be configured as an eccentric disk or as a joint or hinge with suitable lever ratios in order to convert the rotary movement transmitted by the respective drive into a corresponding change in length of the second section of the support element.

Furthermore, the mechanical coupling of the support element adjustment system could also be implemented by means of a gear rack, whereby a movement of the mast relative to the truck body is converted into a change in length of the second section of the support element. In this case, a substantially parallel movement of the second section of the support element can be achieved compared to the deflection of the mast relative to the truck body, with suitable lever ratios between the support element and the mast again being provided, for example to enable different angles of support elements relative to the truck body.

As an alternative to the variant with a mechanical coupling, the support element adjustment system could also comprise a hydraulic coupling between the mast and the support element, with a slave element being assigned to the mast and a length-adjustable master element being assigned to the support element, a movement of the mast relative to the truck body being converted into a change in length of the support element. Here, a corresponding master element could, for example, be implemented directly as a master cylinder, which could act as a length-adjustable second section of the support element, but a more complex design could also be provided, in which, for example, a telescopic length adjustment of the support element is provided and the corresponding master element then drives a corresponding extension and retraction movement of the telescopic system.

A similar, for example direct or telescopic, change in length of the support element could also be achieved by a support element adjustment system comprising an electronic coupling between the mast and the support element, with a detection unit being assigned to the mast and a length-adjustable actuating unit being assigned to the support element, a movement of the mast relative to the truck body being detected by a control unit of the support element adjustment system via the detection unit, and a change in length of the actuating unit being effected on this basis. Here, the detection unit could also be integrated directly with the active position control system, so that a corresponding triggering of the actuating unit can be coordinated with a triggering of the at least one actuator of the position control system. Accordingly, the expected deflections of the mast caused by the actuation of the position control system must be evaluated and applied directly to the actuating unit in order to enable a suitable interaction between the two systems. In this context, the corresponding actuating unit could be configured as an electromechanical actuator in a manner known per se, for example as a linear drive or rotary servo motor with a suitable gear unit for translation into a linear movement, which corresponds to a change in length of the actuating unit and can thus cause the length of the support element to be adjusted.

Although on the industrial truck according to the invention it is also conceivable in principle to provide only a single support element which extends between the aforementioned first and second attachment points on the truck body and the mast, for improved force absorption in relation to the width direction of the industrial truck it may be advantageous if a plurality of support elements are provided, for example two support elements whose respective second attachment points are spaced apart from one another in the width direction of the industrial truck. Naturally, the first attachment points can also be spaced apart in a similar way in the width direction of the mast, with the specific positioning of the individual attachment points depending on the overall geometry of the industrial truck concerned and being, for example, based on the width of both the truck body and the mast.

Furthermore, the industrial truck according to the invention can be configured in particular as a narrow-aisle truck and a vertically displaceable operator's station can be assigned to the mast, so that the corresponding truck can be configured as a so-called “man-up truck”. Especially in trucks of this type it is clear that the operating efficiency and comfort of the operator can be significantly impaired by vibrations occurring in the mast, as the prevailing lever ratios can result in a strong deflection relative to the ground and substantial accelerations, especially with a widely extended load handling attachment or operator's station.

According to a second aspect, the present invention further relates to a method for operating such an industrial truck, comprising detecting vibrations of the mast and/or deflection of the mast by means of at least one sensor unit of the position control system and/or predicting vibrations of the mast by means of a prediction unit of the position control system, triggering at least one actuator of the position control system in order to suppress the detected and/or predicted vibrations and to compensate for the detected deflection of the mast by causing a movement of the mast relative to the truck body, and adjusting the length of the at least one support element so as to compensate for the resulting relative displacement of the second attachment point relative to the first attachment point of the at least one support element.

Other advantages and features of the present invention become clearer from the following description of possible embodiments thereof when considered together with the accompanying figures. These show the following:

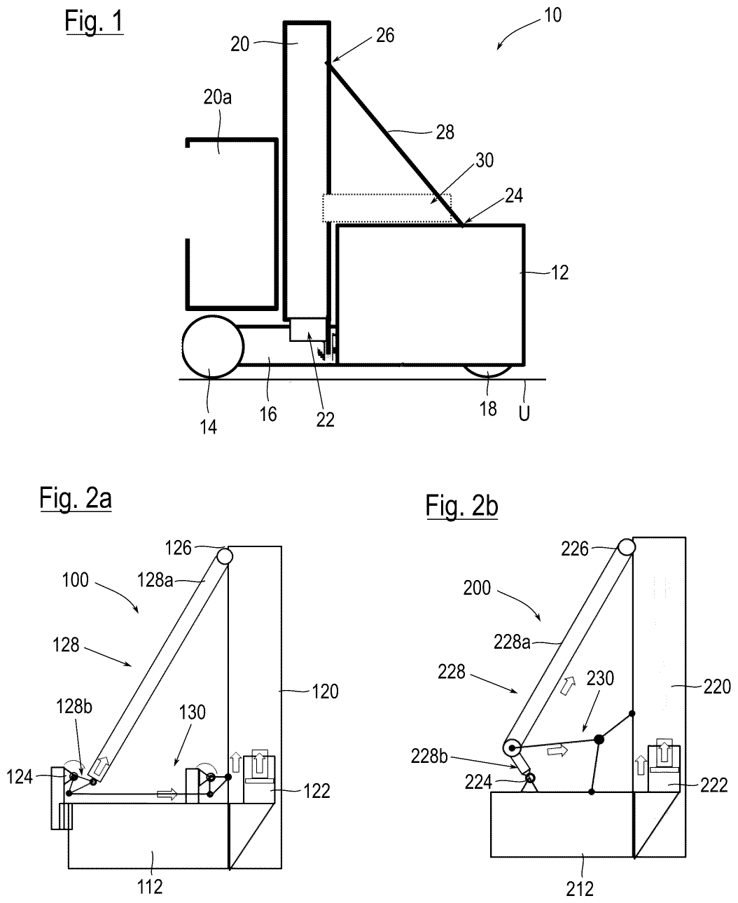

FIG. 1: A schematic side view of an embodiment of an industrial truck according to the invention, which can be combined with different variants of support element adjustment systems, as shown in the subsequent figures.

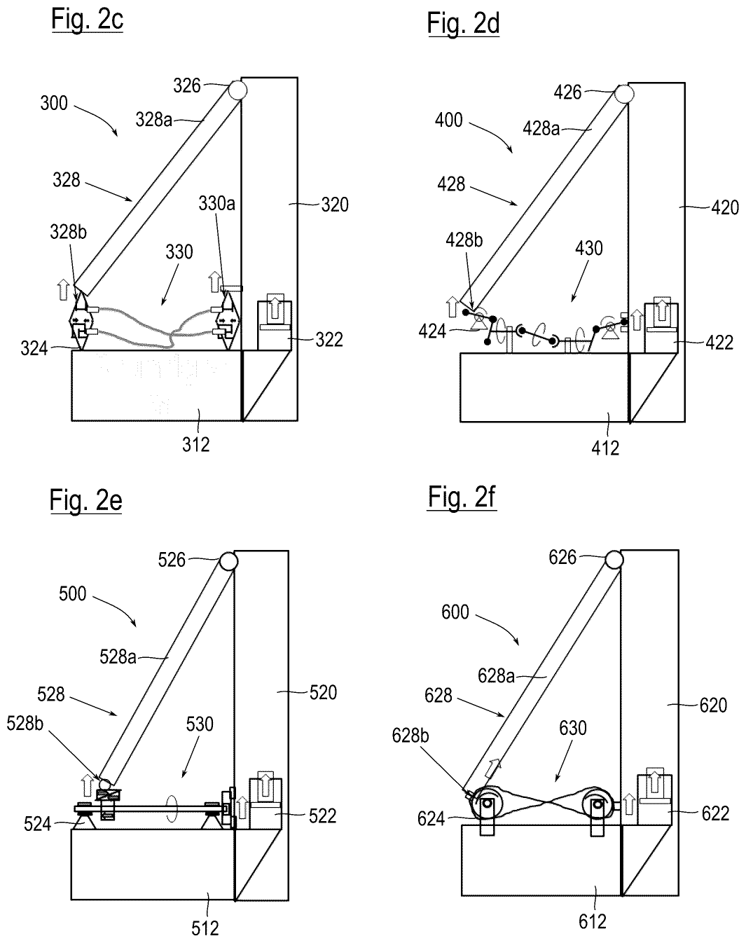

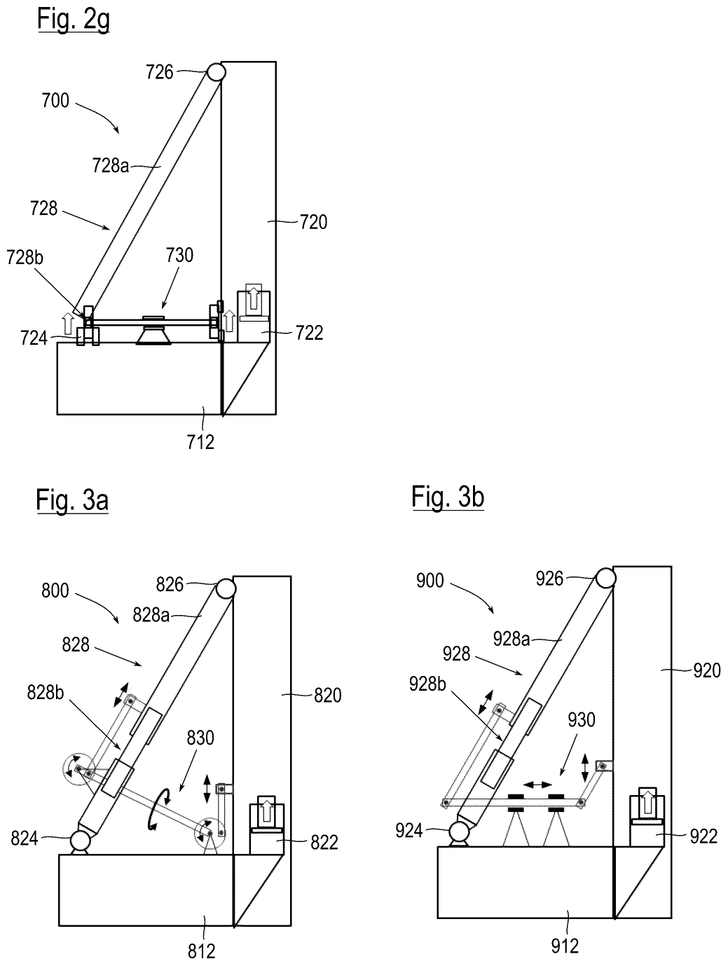

FIGS. 2a to 2g: Specific embodiments of support element adjustment systems with mechanical coupling.

FIGS. 3a and 3b: Embodiments of support element adjustment systems with mechanical coupling and support-integrated length changing.

FIG. 4: An embodiment of a support element adjustment system with hydraulic coupling.

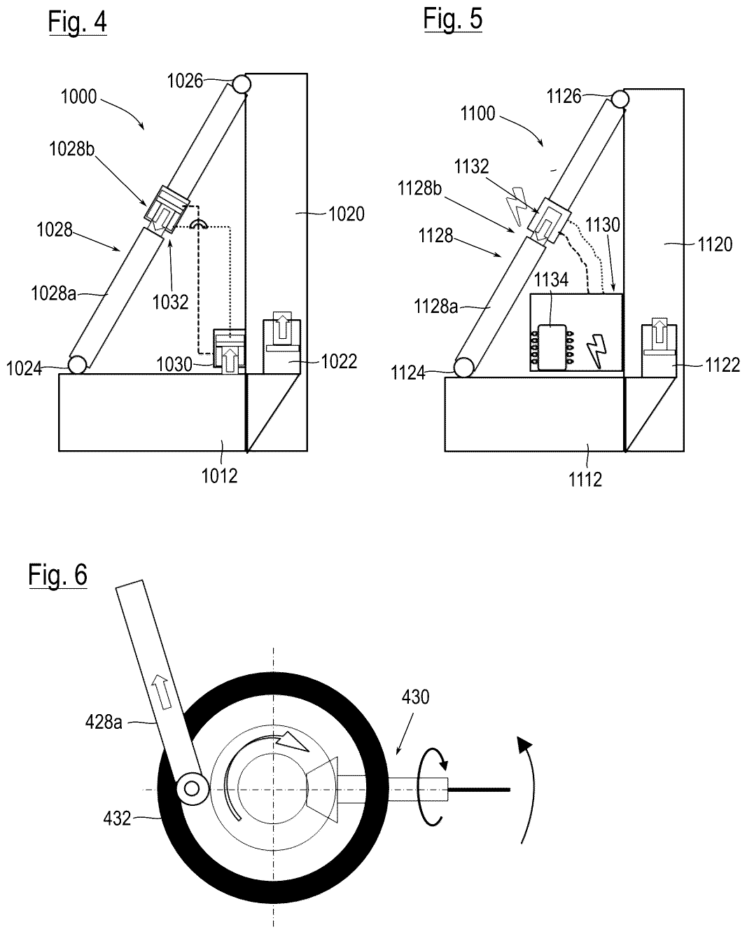

FIG. 5: An embodiment of a support element adjustment system with electronic coupling, and

FIG. 6: A detailed view of a variant of the support element adjustment system from FIG. 2d.

FIG. 1 firstly shows a schematic side view of an industrial truck according to the invention. Here, the industrial truck is generally designated by the reference number 10 and is configured as a narrow-aisle truck. It comprises a truck body 12 with a pair of front wheels 14, which are provided on respective side members 16, and a driven and steered rear wheel 18 with which the truck 10 stands on a driving surface U.

Here, the axes of rotation of the front wheels 14 and of the rear wheel 18 each run in the width direction of the truck 10, while the straight-ahead direction of travel of the truck 10 is also referred to as the longitudinal direction. Between the two axles of the front wheels 14 and of the rear wheel 18 in the longitudinal direction of the truck 10 there extends in a substantially vertical direction a mast 20 to which, in the embodiment shown in FIG. 1, an operator's platform 20a is connected in a vertically displaceable manner.

Due to its design with the mast 20 arranged between the axles of the front wheels 14 and the rear wheel 18, the industrial truck 10 shown here is primarily suitable for use in logistics facilities in which only narrow aisles are provided between high racks, where goods can be put into store by an operator located on the operator's platform 20a. It will be understood that, in alternative variants, the industrial truck 10 could also be configured with an operator's platform permanently attached to the truck body 12 or as a driverless truck and could thus be operated autonomously or remotely, with the operator's platform being replaced by a corresponding superstructure in such variants. It will further be understood that the truck 10 may comprise numerous other components that are common for such trucks, for example a hydraulic system that can drive certain of the actuators described below.

Moreover, the truck 10 comprises an active position control system 22, shown only schematically, which is adapted to effect a relative movement of the mast 20 with respect to the truck body 12 in order to suppress vibrations of the mast 20 and/or to compensate for a deflection of the mast 20 when a load is put into or taken out of store. For this purpose, the position control system 22 can comprise components not further shown here, such as sensor units, actuator units, a control unit and a prediction unit, which evaluate a current status of the truck and/or its environment in a manner known per se and trigger corresponding relative movements of the mast 20 with respect to the truck body 12 in order to suppress vibrations of the mast 20.

The truck further comprises a support element 28, which extends between a first attachment point 24 on the truck body 12 and a second attachment point 26 on the mast 20 in the form of a bracing and serves to transmit forces between the mast 20 and the truck body 12 and thus to support the mast 20. It should be noted here that although only a single support element 28 is shown in FIG. 1, variants of trucks 10 according to the invention with two or more support elements 28 are also conceivable, which can be configured and/or operated in an identical manner.

In the case of a relative movement of the mast 20 with respect to the truck body 12 which is triggered by the active position control system 22 in order to compensate for the changing distance between the attachment points 24 and 26, the industrial truck also comprises a support element adjustment system 30 which is initially shown only schematically in FIG. 1 and which is adapted to adjust the length of the support element 24 in the case of a movement of the mast 20 with respect to the truck body 12. Various embodiments of this support element adjustment system 30 are conceivable, which are explained below with reference to the other figures.

These show different embodiments of trucks according to the invention, which differ essentially in the respective designs of their support element adjustment systems. Therefore, in order to avoid unnecessary duplication of explanations of certain identical or equivalent components, these are each designated with the same reference numbers, increased in each case by a multiple of 100, and reference is made to their general description in the context of the generic exemplary embodiment from FIG. 1. For example, the corresponding masts are each labeled 120, 220, 320, . . . while the truck bodies are labeled 112, 212, 312, . . . and a description of each is omitted. FIGS. 2a to 2g, 3a and 3b each show variants of support element adjustment systems with mechanical coupling between the mast 20 and the support element 28 of the truck 10 from FIG. 1. In all the figures described below, the corresponding movements of the individual components in the case of a movement of the respective mast are also illustrated by means of arrows.

A first example of this is shown in FIG. 2a and designated by the reference number 100, wherein the support element 128 comprises a first section 128a and a second section 128b and the change in length of the support element 128 is only accomplished by the second section 128b, which is configured as a rotatable element that can compensate for a different distance between the first attachment point 124 and the second attachment point 126 of the support element 128 depending on the angular position.

For this purpose, the support element adjustment system 100 further comprises a linkage 130 which can convert a translation of a relative movement of the mast 120 with respect to the truck body 112 into a corresponding pivoting movement of the second section 128b of the support element 128 in order to suitably adjust its length to the deflection of the mast 120. This ensures that the support element 128 is of a correct length in every deflection state of the mast 120, the respective configuration of the lever ratios of the second section 128b of the support element 128 and of the linkage 130 being adapted to the specific geometric conditions of the truck 10, and the specific movements of the linkage 130 and of the second section 128b of the support element 128 being traceable by means of the arrows shown in FIG. 2a.

Similarly, FIG. 2b shows an embodiment in which the support element adjustment system 200 comprises an articulated lever 230 which can also cause a pivoting of the second portion 228b of the support element 228 and thus a change in the length thereof. This variant is characterized in that only swivel joints and simple components are required, although it is not possible to achieve complete freedom from stress in the joints, and the coupling rod that is used must be adjustable.

A further variant is shown in FIG. 2c, in which an arrangement of Bowden cables 330 is used together with a corresponding second section 328b of the support element 328, which is length-adjustable in both directions according to a counter element 330a assigned to the mast 320 based on the effects of the Bowden cables 330, that is to say, it can be both lengthened and shortened in order to compensate for all corresponding movements of the mast 320 relative to the truck body 312.

A further variant of a support element adjustment system 400 is shown in FIG. 2d, providing a cardan shaft 430 which, in a similar manner to the embodiments shown in FIGS. 2a and 2b, causes the second section 428b of the support element 428 to rotate so as to adjust its length when the mast 420 is deflected. In this embodiment, it is apparent that a high force transmission and an almost rigid connection are possible due to the provided cardan shaft 430, furthermore great flexibility is achieved with regard to the length thereof. On the other hand, this solution is of relatively complex design, as intermediate bearings are necessary and more space is required. Furthermore, input and output gears are necessary in each case in order to convert the initially linear movement of the mast 420 relative to the truck body 412 into a rotary movement, which then has to be further converted into a pivoting movement of the second section 428b of the support element 428.

A further variant is shown in FIG. 2e, in which a spindle drive 530 is used in a support element adjustment system 500. In contrast to the embodiment with a cardan shaft 430 in FIG. 2d, a completely rigid connection can be used here and the corresponding spindle drive can be self-locking. Although a high force transmission is also possible in this embodiment, at the same time accurate bearing support of the shaft of the spindle drive 530 is necessary and higher manufacturing costs are to be expected with this variant.

FIG. 2f shows an embodiment with a chain or belt drive, in which the mechanical coupling of the support element adjustment system 600 is achieved via a coupling of the mast 620 to a hub of the chain or belt drive 630, and the second section 628b of the support element 628 is configured as an eccentric disk, which leads to a change in the overall length of the support element 628 in the event of a rotation triggered by the chain or belt drive 630.

A further variant with mechanical coupling is shown in FIG. 2g as a support element adjustment system 700 with a gear rack unit 730, which may translate a movement of the mast 720 relative to the truck body 712 directly into a parallel movement of the second section 728b of the support element 728 with respect to a corresponding displacement element on the mast 720. This variant, too, offers an almost rigid connection and the possibility of high force transmission, but requires accurate bearing support of the corresponding shaft.

FIGS. 3a and 3b show two variants 800 and 900 of support element adjustment systems, in which the length-variability of the support elements 828 and 928 is implemented in a “support-integrated” manner in each case, i.e. the length-variable second section 828b or 928b of the support elements 828 and 928 is not arranged directly in the region of the first attachment points 824, 924, but rather in a section at a distance therefrom in relation to the longitudinal extent of the support element 828 or 928. Thus, in these two variants, the corresponding first section 828a or 928a is in each case configured in two parts and extends on either side of the respective second section 828b or 928b.

In variant 800, a mechanical coupling 830 is provided, which first converts a movement of the mast 820 into a rotary movement of a shaft, which is again converted into a linear movement in the region of the support element 828, which enables telescoping of the support element 828 in the region of the second section 828b. In variant 900, on the other hand, a mechanical coupling 930 is used which converts a movement of the mast 920 relative to the truck body 912 in a guided manner, via a lever mechanism through a forward and backward movement of a shaft, into a telescopic movement of the support element 928.

In contrast to the previously discussed variants with mechanical coupling, FIG. 4 shows a variant of a support element adjustment system 1000 with a hydraulic coupling, in which a hydraulic slave cylinder 1030 is assigned to the mast 1020, while a master cylinder 1032 acting as a variable-length second section 1028b is assigned to the support element 1028. Here, by suitably configuring the two cylinders 1030 and 1032, a geometric relationship can be created which causes a corresponding lengthening or shortening of the support element 1028 when the mast 1020 is deflected relative to the truck body 1012. In particular, the slave cylinder 1030 can hydraulically transmit the movement of the mast 1020 in the same direction to the master cylinder 1032, and the respective hydraulic volume of the two cylinders 1030 and 1032 can be adapted to the inclination of the support element 1028 relative to the truck body 1012.

Similarly, an electronic support element adjustment system 1100 is shown in FIG. 5, in which an electronic coupling is provided between the mast 1120 and the support element 1128, a detection unit 1130 being assigned to the mast 1120 and a length-adjustable actuating unit 1132 being assigned to the support element 1128, a movement of the mast 1120 relative to the truck body 1112 being detected by a control unit 1134 of the support element adjustment system 1100 and a change in length of the actuating unit 1132 being effected on this basis. Here, the actuating unit 1132 can act directly as a length-adjustable second section 1128b of the support element 1128 or, for example, drive a telescopic section of the support element 1128 in order to make it extend and retract. Furthermore, it should be noted that the detection unit 1130 and its control unit 1134 can also be directly integrated with the control unit, which is not shown further, of the position control system 1122 and the triggering of the actuating unit 1132 can be coordinated with the triggering of the at least one actuator of the position control system 1122 on the basis of detected data concerning a state of the truck 10 or its environment.

Finally, FIG. 6 shows a detailed view of the variants from FIG. 2d from which it can be clearly seen that the cardan shaft 430 acts on an eccentric wheel 432, which in turn carries the first section 428a of the support element 428 and, by rotation, displaces the eccentric wheel accordingly into a position which corresponds to a different length of the corresponding support element 428 in order to compensate for the movement of the mast 420 which initially triggered the rotation of the cardan shaft 430. Thus, in this variant, the eccentric wheel 432 precisely corresponds to the length-adjustable second section 428b of the support element 428.

1. An industrial truck, comprising:
a truck body having a longitudinal direction and a width direction;
a mast extending vertically from the truck body;
an active position control system adapted to effect a relative movement of the mast relative to the truck body;
at least one support element extending between a first attachment point on the truck body and a second attachment point on the mast; and
a support element adjustment system adapted to adjust a length of the support element when the mast moves relative to the truck body to compensate for resulting relative displacement of the second attachment point relative to the first attachment point.

2. The industrial truck according to claim 1, wherein the position control system is adapted to pivot the mast about an axis parallel to the longitudinal direction of the truck body.

3. The industrial truck according to claim 1, wherein;
the at least one support element comprises a rigid first section and a second section, wherein the second section is length-adjustable with respect to the first attachment point; and
the support element adjustment system comprises a mechanical coupling between the mast and the second section.

4. The industrial truck according to claim 3, wherein the mechanical coupling of the support element adjustment system comprises a linkage attached to the mast via a pivotable element, wherein the linkage causes the second section of the support element to pivot in order to change the length of the support element.

5. The industrial truck according to claim 3, wherein the mechanical coupling of the support element adjustment system comprises a Bowden cable, wherein the Bowden cable is attached to the mast and is adapted to cause a change in the length of the support element when the mast moves relative to the truck body.

6. The industrial truck according to claim 3, wherein:
the mechanical coupling of the support element adjustment system comprises a corresponding drive attached to the mast;
the corresponding drive includes at least one of a cardan shaft, a spindle drive, a chain drive, or a belt drive;
a rotary movement of the corresponding drive is triggered when the mast moves relative to the truck body; and
the rotary movement causes the second section of the support element to pivot thereby leading to a change in the length of the support element.

7. The industrial truck according to claim 3, wherein the mechanical coupling of the support element adjustment system comprises a gear rack, and wherein a movement of the mast relative to the truck body is converted into a change in h length of the second section of the support element.

8. The industrial truck according to claim 1, wherein the support element adjustment system comprises:
a hydraulic coupling between the mast and the support element;
a slave element attached to the mast; and
a length-adjustable master element attached to the support element, wherein the length-adjustable master element is adapted to convert a movement of the mast relative to the truck body into a change in the length of the support element.

9. The industrial truck according to claim 1, wherein the support element adjustment system comprises an electronic coupling positioned between the mast and the support element, and further comprising:
a detection unit attached to the mast; and
a length-adjustable actuating unit attached to the support element (1128), wherein a control unit of the detection unit is adapted to detect a movement of the mast relative to the truck body, and wherein the length-adjustable actuating unit is adapted to change in length based on the movement.

10. The industrial truck according to claim 1, further comprising:
a plurality of support elements each having a respective second attachment point on the mast, wherein each of the respective second attachment points are spaced apart from one another in the width direction of the industrial truck.

11. The industrial truck according to claim 1, wherein the industrial truck comprises a narrow-aisle truck, and wherein the mast further comprises a vertically displaceable operator station.

12. A method of operating an industrial truck comprising:
detecting, using at least one sensor unit of a position control system, vibrations of a mast, wherein the mast vertically extends from a truck body of the industrial truck, and wherein at least one support element extends between a first attachment point on the truck body and a second attachment point on the mast;
triggering at least one actuator of the position control system to suppress the detected vibrations, wherein suppressing the detected vibrations comprises compensating for the detected vibrations by causing a movement of the mast relative to the truck body; and
responsive to causing the movement of the mast, adjusting a length of the at least one support element to thereby compensate for a resulting relative displacement of the second attachment point relative to the first attachment point of the at least one support element.

13. The method of claim 12, further comprising:
detecting, using the at least one sensor unit of the position control system, deflections of the mast;
suppressing the detected deflections by compensating for the detected deflections by causing a movement of the mast relative to the truck body; and
responsive to causing movement of the mast, adjusting the length of the at least one support element to thereby compensate for the resulting relative displacement.

14. The method of claim 13, wherein deflections of the mast are associated with a load being placed into or taken out of the industrial truck.

15. The method of claim 12, further comprising:
predicting, using a prediction unit of the position control system, vibrations of the mast;
suppressing the predicted vibrations by compensating for the predicted vibrations by causing a movement of the mast relative to the truck body; and
responsive to causing movement of the mast, adjusting the length of the at least one support element to thereby compensate for the resulting relative displacement.

16. The method of claim 15, wherein the prediction unit of the position control system is adapted to predict vibrations of the mast based on a detected current spatial status, a detected current movement status of the industrial truck, and a knowledge of an environment of the industrial truck.

17. The method of claim 15, wherein suppressing the predicted vibrations comprises pre-compensating for the predicted vibrations via movement of the mast before the predicted vibrations occur.

18. The method of claim 15, wherein the prediction unit is further adapted to predict future deflections of the mast, wherein the future deflections are associated with a load being placed into or taken out of the industrial truck, and wherein the method further comprises:
suppressing the future deflections by compensating for the future deflections by causing a movement of the mast relative to the truck body; and
responsive to causing movement of the mast, adjusting the length of the at least one support element to thereby compensate for the resulting relative displacement.

19. The method of claim 12, wherein the position control system is adapted to pivot the mast about an axis parallel to a longitudinal direction of the truck body.

20. The method of claim 12, wherein the at least one support element comprises a rigid first section and a second section, wherein the second section is length-adjustable with respect to the first attachment point, and wherein second section is connected to the mast via a mechanical coupling.
